(19) United States
(12) Patent Application Publication
(10) Pub. No.: US 2009/0001093 A1
(43) Pub. Date: Jan. 1, 2009

(54) INTELLIGENT MEDICATION TRACKER

(76) Inventor: Michael Labhard, Lake Oswego, OR (US)

Correspondence Address: INTEL CORPORATION;c/o INTELLEVATE, LLC, P.O. BOX 52050, MINNEAPOLIS, MN, 55402, US

(21) Appl. No.: 11/771,339

(22) Filed: Jun. 29, 2007

(51) Int. Cl. A61J 7/04

(52) U.S. Cl. 221/1; 221/7; 221/8

(57) ABSTRACT

A medication dispenser comprises slots that may be sized to accommodate medication containers of various sizes. Each slot has an associated barcode reader. A user inserts the pharmacy-provided pill or medication container into one slot. The barcode on the container is read. From the barcode the medication in the container is identified. The device contains a simple user interface that allows the user to enter the dosing frequency prescribed, how many pills or cc's are in the container, how many refills and a starting time. The dispenser alerts users to possible drug interactions with medications in other slots as well as alerts them to dosing times and other pertinent information.

### FIELD OF THE INVENTION

Embodiments of the present invention are directed to the dosing of prescription and over the counter (OTC) medication and, more particularly, to device and method for managing medications.

### BACKGROUND INFORMATION

The correct dosing of medications and various medication interactions when taking multiple medications is a serious concern to a large number of people, particularly with an aging population having an ever increasing reliance on multiple drugs. Accidental overdoses, under doses, or interactions can have serious and sometimes fatal consequences to ones health.

As just one example, the liver is an organ that metabolizes many drugs once introduced into the body. Drugs may cause serious injury to the liver, with loss of function resulting in illness, disability, hospitalization, or even life-threatening liver failure. As more and more drugs are taken by our aging world population, the chance of sustaining such injury rises, compounded by use also of over-the-counter medications, so-called “dietary supplements,” alcohol consumption, and by exposure to environmental chemicals.

Drug-induced liver injury is now the most frequent cause of acute liver failure in the United States, exceeding all other causes combined. Fortunately, the liver is a robust organ, and often can withstand injury by resisting damage, heating, regenerating. But in some persons who are especially susceptible or in whom heating is not adequate, serious and progressive illness may occur.

Further, studies indicate that in the first few days of each month, fatalities due to medication errors rise by as much as 25 percent above normal. This is thought to be due to a beginning-of-the-month increase in pharmacy workloads and a consequent increase in their error rates.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram showing the intelligent medication tracker according to one embodiment of the invention; and

FIG. 2 is a flow diagram showing steps and features of the medication tracker according to one embodiment.

### DETAILED DESCRIPTION

Described is a device and method which assists a user in managing their medications regimen by identifying which medications they are taking, when and how much of each medication should be taken, when refills are required and alerts them to dangerous interactions.

Reference throughout this specification to “one embodiment,” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Recently, in an effort to improve patient safety in the hospital setting by reducing medication errors, the Food and Drug Administration (FDA) indicated rules that require linear bar codes on most prescription drugs and on over-the-counter drugs commonly used in hospitals and dispensed pursuant to an order. The bar code must, at a minimum, contain the drug's National Drug Code (NDC) number, which uniquely identifies the drug.

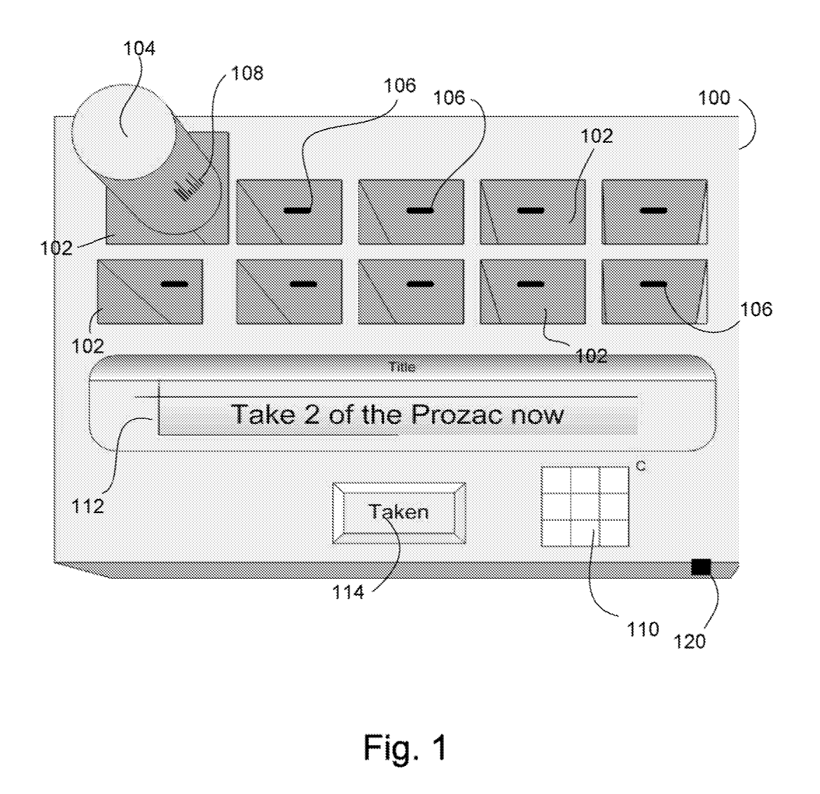

Referring now to FIG. 1, embodiments of the invention comprise a box like apparatus 100 with slots 102 that may be manually sized to accommodate medication containers 104 of various sizes. Each slot may have an associated barcode reader 106. A user inserts the pharmacy-provided pill or medication container 104 into one slot 102. The barcode 108 on the container 104 is read. From the barcode 108 the medication in the container 104 may be identified. The device contains a simple user interface, which may include a keypad 110, that allows the user to enter the dosing frequency prescribed, how many pills or cc's are in the container 104, how many refills and a starting time. A display 112 may also be included to display information such as text as well as a “taken” button 114.

Software may be provided to determine when the next dose of each medication should be taken and alerts the user when the time is due. The medication to be taken is identified to the user by name on the user display 112 and by identifying the container with the associated barcode by highlighting the associated slot containing the appropriate medication, such as by illuminating the slot 102 or unlocking a cover over the slot 102. The user interface or display 112 may also indicate the dose to be taken at the current time. When the user has taken the medication they press the “Taken” button 114 and the device returns to the state between doses.

The software supporting the device is capable of identifying drug interactions and overdose conditions and it will alert the user when they have specified a regimen that may be toxic such as by having a built-in database of such information which may be updated periodically.

Since a physician is usually unable to monitor all the over-the-counter (OTC) medications a patient may be taking, and since OTC medications may have extremely dangerous interactions, this device provides a level of protection from dangerous interactions between prescribed and OTC medications, as well as providing a double-check on pharmacy errors. It also relieves the user of the burden of following a complex drug regimen, by identifying which drug is to be taken at the time it is to be taken and in what dosage.

The device may further determine when a refill is imminent by calculating the remaining amount after each dose is taken. The need to refill a medication prescription is determined when the bottle's quantity has fallen below a 3 day supply, for example. The user interface then alerts the user to the condition.

The device may alert the user to take medication at the earliest time that it is safe to take it. The alert will continue until the medication is taken. If any dose is late the software may contain rules that will allow either catch up or otherwise get back on schedule with the prescribed regimen by adjusting the times of future doses appropriately, specific to the medication being taken. Significant noncompliance can be identified by the software and the user can be alerted to contact their physician for advice.

Since the interactions are determined when the medications are inserted into the slots 102 by the barcode 108 it is possible for a physician who wishes to override the warning alerts in a particular circumstance to load the device themselves and to turn off the dangerous interaction warning for a particular medication by pressing a concealed button 120 on the side of the device when the warning of interest is showing.

The history of dosing alert times and the corresponding “Taken” button 114 press times may be stored for each medicine and can be downloaded for analysis by user's physician for a detailed study of compliance.

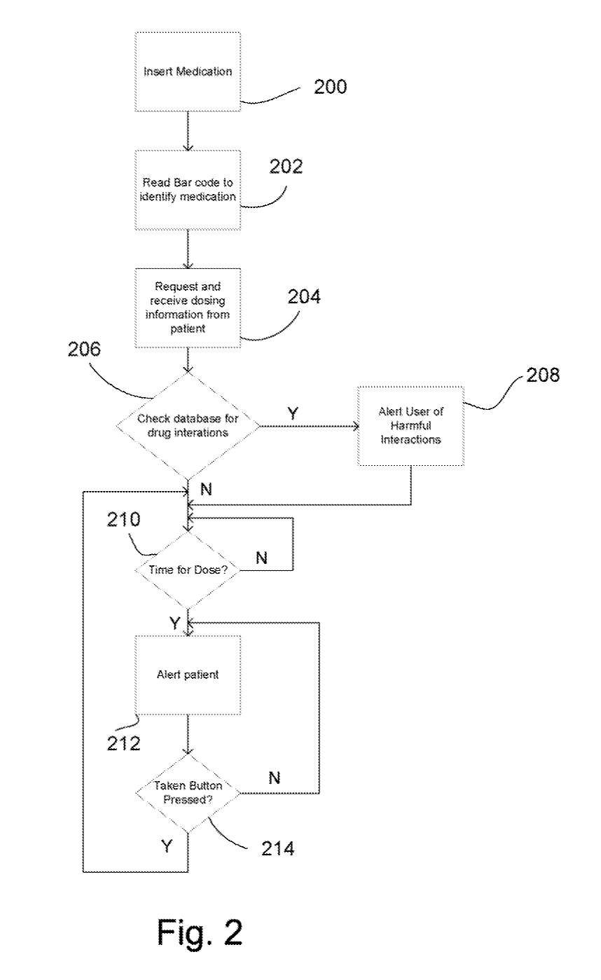

Referring now to FIG. 2, there is shown a flow diagram illustrating various features of the present invention. At block 200, a medication container 104 is inserted into one of the slots 102. At block 202, the bar code 108 on the container is read by bar code reader 106 to identify the particular medication in the bottle 104. At block 204, the patient is prompted by the display 112 to enter dosing information, such as the number of pills/cc's, dosing frequency, number of refills, etc. The patient may also be prompted to enter the first dose time.

All or some of this information may be entered manually, or in the future this information may be contained in the bar code 104. Also, while bar codes are used here for illustrative purposes, other means of machine readable information, such as RF tags and RF readers may also be used.

At block 206, embodiments check the database to determine if there are any drug interactions with other drugs already stored in the device or other precautions. If any are found, the user is alerted of the situations such as by the display 112 and/or an audible warning at block 208. The user may further be alerted to contact their physician about the interaction. If no interactions are determined to exist, the device enters a wait state as it waits until it is time for the next dose of the medication at block 210. At block 212, when it is time for the next dose, the patient is alerted of such. The display 112, may indicate the name and slot 102 where the medication may be found as well as the prescribed dose along with any other pertinent information, such as “take with food”, “caution driving”, etc. Once taken, the user pushes the “taken” button 114, block 214, and the device again waits until the next dose at block 210.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A medication dispensing device, comprising:
a housing including a plurality of slots sized to accommodate a drug container;
a reader associated with each slot for reading a machine readable label on the drug container;
a database to store information pertaining to a drug in the drug container;
a user interface to enter data related to the drug;
a display to alert a user when it is time to take a dose of the drug; and
a button to be pressed when the drug has been taken.

2. The device as recited in claim 1, where the display further alerts the user of drug interaction with drugs in other slots.

3. The device as recited in claim 1, wherein the reader is a barcode reader.

4. The device as recited in claim 1, wherein the reader is an RF tag reader.

5. The device as recited in claim 1, further comprising:
a button to override a drug interaction alert.

6. The device as recited in claim 1 wherein the user interface comprises a keypad to manually enter dosing information.

7. A method, comprising:
inserting a drug container having a machine readable code into a slot;
machine reading the code to determine information pertaining to a drug stored in the drug container;
determining any drug interactions with another drug in another slot;
alerting a patient when it is time to take a dose of the drug; and
receiving an input from the patient when the drug has been taken.

8. The method as recited in claim 7 wherein the machine readable code is a barcode.

9. The method as recited in claim 8 wherein the information pertaining to the drug comprises the type of drug and dosing information.

10. The method as recited in claim 8, further comprising:
manually entering dosing information into a keypad.

11. The method as recited in claim 7 further comprising:
alerting the patient to a drug interaction.

12. The method as recited in claim 11 further comprising:
a button for overriding a drug interaction alert.

13. The method as recited in claim 7 further comprising displaying dose information and drug interactions on a display.
